(19) United States
(12) Patent Application Publication
(10) Pub. No.: US 2011/0268204 A1
(43) Pub. Date: Nov. 3, 2011

(54) MULTIPLE INPUT MULTIPLE OUTPUT COMMUNICATION SYSTEM OF SUPPORTING SEVERAL REPORTING MODES

(75) Inventors: Jun Il CHOI, Seoul (KR); Bruno Clerckx, Seoul (KR); Ki Il Kim, Yongin-si (KR); Joon Young Cho, Suwon-si (KR); Jin Kyu Han, Seoul (KR)

(73) Assignee: SAMSUNG ELECTRONICS CO., LTD., Suwon-si (KR)

(21) Appl. No.: 13/098,765

(22) Filed: May 2, 2011

Related U.S. Application Data
(60) Provisional application No. 61/329,634, filed on Apr. 30, 2010.
(60) Provisional application No. 61/355,681, filed on Jun. 17, 2010.
(60) Provisional application No. 61/356,768, filed on Jun. 21, 2010.

(30) Foreign Application Priority Data
Feb. 17, 2011 (KR) 10-2011-0014052

(51) Int. Cl. H04L 27/28; H04L 27/06; H04L 25/49

(52) U.S. Cl. 375/260; 375/296; 375/340

(57) ABSTRACT

A plurality of reporting modes used to report feedback information is provided. A transmitter and a receiver generate and share feedback information based on a corresponding reporting mode.

### CROSS-REFERENCE TO RELATED APPLICATION(S)

This application claims the benefit under 35 U.S.C. §119(e) of U.S. Provisional Application No. 61/329,634, filed on Apr. 30, 2010, U.S. Provisional Application No. 61/355,681, filed on Jun. 17, 2010, and U.S. Provisional Application No. 61/356,768, filed on Jun. 21, 2010, all of which were filed in the United States Patent and Trademark Office. This application also claims the benefit under 35 U.S.C. §119(a) of Korean Patent Application No. 10-2011-0014052, filed on Feb. 17, 2011, in the Korean Intellectual Property Office, the entire disclosures of which are all incorporated herein by reference for all purposes.

### BACKGROUND

1. Field

The following description relates to a multiple-input multiple-output (MIMO) communication system and, more particularly, to technology for sharing feedback information between a transmitter and a receiver in a MIMO communication system.

2. Description of Related Art

A multiple-input multiple-output (MIMO) communication system includes a transmitter and at least one receiver. For example, the MIMO communication system may include a base station and at least one terminal. In a downlink communication, the base station may operate as the transmitter, and each of the at least one terminal may operate as the receiver.

The transmitter or the receiver operating in the MIMO communication system may include a plurality of antennas, and may transmit and receive data using the plurality of antennas. A wireless channel may be formed between each transmit antenna of the transmitter and each receive antenna of the receiver. The transmitter and the receiver may share information associated with the wireless channel to improve the data rate.

In a closed-loop MIMO communication system, feedback information to be shared between the transmitter and the receiver may include a rank indicator indicating a preferred rank of the receiver, a precoding matrix indicator indicating a preferred precoding matrix, channel quality information indicating a quality of a wireless channel, and the like. The receiver may select one of a plurality of matrices or vectors included in a codebook using a predefined codebook. Accordingly, the receiver may feed back an index of the selected matrix or vector as the precoding matrix indicator.

### SUMMARY

In one general aspect, there is provided a communication method of a receiver, including determining a reporting mode according to feedback information to be transmitted to a transmitter, generating, from a first codebook, a first precoding matrix indicator with respect to a set of a plurality of subbands, generating, from a second codebook, a second precoding matrix indicator with respect to at least one subband among the plurality of subbands, and transmitting the feedback information to the transmitter, wherein the feedback information comprises the first precoding matrix indicator and the second precoding matrix indicator.

The communication method may further include generating channel quality information associated with the set of the plurality of subbands, based on a precoding matrix that corresponds to each of the first precoding matrix indicator and the second precoding matrix indicator, wherein the feedback information further includes the channel quality information.

The feedback information may be transmitted via a physical uplink shared channel (PUSCH).

The first codebook and the second codebook may be different from each other, and each of the first codebook and the second codebook may correspond to a subset of the same full codebook.

The channel quality information may be generated based on a predetermined rank indicator or a rank indictor determined in the receiver. In another general aspect, there is provided a communication method of a transmitter, including determining a reporting mode according to feedback information transmitted from a receiver to the transmitter, receiving a first precoding matrix indicator and a second precoding matrix indicator that are transmitted by the receiver according to the reporting mode, and generating a precoding matrix based on the first precoding matrix indicator and the second precoding matrix indicator. In the reporting mode, the first precoding matrix indicator may be generated from a first codebook with respect to a set of a plurality of subbands, and the second precoding matrix indicator may be generated from a second codebook with respect to each at least one subband among the plurality of subbands.

The communication method may further include receiving channel quality information associated with the set of the plurality of subbands.

In the reporting mode, the channel quality information may be generated based on the precoding matrix that corresponds to each of the first precoding matrix indicator and the second precoding matrix indicator.

The first precoding matrix indicator and the second precoding matrix indicator may be received via a physical uplink shared channel (PUSCH).

The first codebook and the second codebook may be different from each other, and each of the first codebook and the second codebook may correspond to a subset of the same full codebook.

In still another general aspect, there is provided a communication method of a receiver, including determining a reporting mode according to feedback information to be transmitted to a transmitter, generating, from a first codebook, a first precoding matrix indicator with respect to a set of a plurality of subbands or at least one subband among the plurality of subbands, generating, from a second codebook, a second precoding matrix indicator with respect to the set of the plurality of subbands or at least one subband among the plurality of subbands, and transmitting the feedback information to the transmitter, wherein the feedback information includes the first precoding matrix indicator and the second precoding matrix indicator.

The communication method may further include generating channel quality information associated with the set of the plurality of subbands, based on a precoding matrix that corresponds to each of the first precoding matrix indicator and the second precoding matrix indicator, wherein the feedback information further includes the channel quality information.

The communication method may further include generating differential information with respect to the channel quality information associated with the set of the plurality of subbands and channel quality information associated with a predetermined subband among the plurality of subbands, wherein the feedback information further includes the differential information.

The first codebook and the second codebook may be different from each other, and each of the first codebook and the second codebook may correspond to a subset of the same full codebook.

The channel quality information may be generated based on a predetermined rank indicator or a rank indicator determined in the receiver.

In yet another general aspect, there is provided a communication method of a transmitter, including determining a reporting mode according to feedback information transmitted from a receiver to the transmitter, receiving a first precoding matrix indicator and a second precoding matrix indicator that are transmitted by the receive according to the reporting mode, and generating a precoding matrix based on the first precoding matrix indicator and the second precoding matrix indicator. In the reporting mode, the first precoding matrix indicator may be generated from a first codebook with respect to a set of a plurality of subbands or at least one subband among the plurality of subbands, and the second precoding matrix indicator may be generated from a second codebook with respect to the set of the plurality of subbands or at least one subband among the plurality of subbands.

The communication method may further include receiving channel quality information associated with the set of the plurality of subbands.

The communication method may further include receiving differential information with respect to the channel quality information associated with the set of the plurality of subbands and channel quality information associated with a predetermined subband among the plurality of subbands

In a further another aspect, there is provided a communication method of a receiver, including generating a rank indicator indicating a preferred rank of the receiver, generating, from a first codebook, a first precoding matrix indicator with respect to a set of a plurality of subbands or a predetermined subband among the plurality of subbands, generating, from a second codebook, a second precoding matrix indicator with respect to the set of the plurality of subbands, generating channel quality information associated with the set of the plurality of subbands, and transmitting the rank indicator at a first reporting time, transmitting the first precoding matrix indicator at a second reporting time, and transmitting the second precoding matrix indicator and the channel quality information at a third reporting time.

The first reporting point in time, the second reporting time, and the third reporting time may each correspond to a different subframe.

The second precoding matrix indicator and the channel quality information may be jointly coded for transmission.

The transmitting of the rank indicator, the first precoding matrix indicator, the second precoding matrix, and the channel quality information may further include transmitting the rank indicator based on a first reporting period, transmitting the first precoding matrix indicator based on a second reporting period, and transmitting the second precoding matrix indicator and the channel quality information based on a third reporting period.

The channel quality information may be generated according to the first precoding matrix indicator and the second precoding matrix indicator.

In still another general aspect, there is provided a communication method of a transmitter, including determining a reporting mode according to feedback information transmitted from a receiver to the transmitter, receiving, from the receiver, a rank indicator at a first reporting time, receiving a first precoding matrix indicator at a second reporting time, and receiving a second precoding matrix indicator with respect to a set of a plurality of subbands and channel quality information associated with the set of the plurality of subbands at a third reporting time, determining, based on the reporting mode, the rank indicator, the first precoding matrix indicator, the second precoding matrix indicator, and the channel quality information, and generating a precoding matrix based on at least the first precoding matrix indicator and the second precoding matrix indicator.

The first reporting time, the second reporting time, and the third reporting time may each correspond to a different subframe.

The receiving may further include receiving the rank indicator based on a first reporting period, receiving the first precoding matrix indicator based on a second reporting period, and receiving the second precoding matrix indicator and the channel quality information based on a third reporting period.

In still another general aspect, there is provided a communication method of a receiver, including generating a rank indicator indicating a preferred rank of the receiver, generating, from a first codebook, a first precoding matrix indicator with respect to a set of a plurality of subbands or at least one predetermined subband among the plurality of subbands, generating, from a second codebook, a second precoding matrix indicator with respect to the set of the plurality of subbands, generating first channel quality information associated with the set of the plurality of subbands, generating a third precoding matrix indicator with respect to each predetermined subband among the plurality of subbands, generating second channel quality information associated with each predetermined subband among the plurality of subbands, and transmitting the rank indicator at a first reporting time, transmitting the first precoding matrix indicator at a second reporting time, transmitting the second precoding matrix indicator and the first channel quality information at a third reporting time, and transmitting the third precoding matrix indicator and the second channel quality information at a fourth reporting time.

The first reporting time, the second reporting time, the third reporting time, and the fourth reporting time may each correspond to a different subframe.

The transmitting may further include transmitting the rank indicator based on a first reporting period, transmitting the first precoding matrix indicator based on a second reporting period, transmitting the second precoding matrix indicator and the channel quality information based on a third reporting period, and transmitting the third precoding matrix indicator and the channel quality information based on a fourth reporting period.

In still another general aspect, there is provided a communication method of a transmitter, including determining a reporting mode according to feedback information transmitted from a receiver to the transmitter, receiving, from the receiver, a rank indicator at a first reporting time, receiving a first precoding matrix indicator with respect to a set of a plurality of subbands or at least one predetermined subband among the plurality of subbands at a second reporting time, receiving a second precoding matrix indicator with respect to the set of the plurality of subbands and first channel quality information associated with the set of the plurality of subbands at a third reporting time, and receiving a third precoding matrix indicator with respect to each predetermined subband and second channel quality information associated with each predetermined subband at a fourth reporting time, determining, based on the reporting mode, the rank indicator, the first precoding matrix indicator, the second precoding matrix indicator, the first channel quality information, the third precoding matrix indicator, and the second channel quality information, and generating a precoding matrix based on at least the first precoding matrix indicator, the second precoding matrix indicator, and the third precoding matrix indicator.

The first reporting time, the second reporting time, the third reporting time, and the fourth reporting time may each correspond to a different subframe.

The receiving may further include receiving the rank indicator based on a first reporting period, receiving the first precoding matrix indicator based on a second reporting period, receiving the second precoding matrix indicator and the first channel quality information based on a third reporting period, and receiving the third precoding matrix indicator and the second channel quality information based on a fourth reporting period.

In still another general aspect, there is provided a communication apparatus installed in at least one of a transmitter and a receiver, including a memory configured to store a first codebook and a second codebook, a processor configured to generate a corresponding precoding matrix indicator from each of the first codebook and the second codebook, and to extract a precoding matrix associated with the corresponding precoding matrix indicator, and a communication interface configured to transmit and/or receive, between the transmitter and the receiver, the corresponding precoding matrix indicator generated from each of the first codebook and the second codebook, wherein the first codebook and the second codebook are subsets of a full codebook.

The above methods may be implemented by a program stored in a non-transitory computer-readable recording medium.

Other features and aspects may be apparent from the following detailed description, the drawings, and the claims.

### BRIEF DESCRIPTION OF THE DRAWINGS

FIG. 1 is a diagram illustrating an example of a multi-user multiple input multiple output (MIMO) communication system.

FIG. 2 is a diagram illustrating an example of a communication method of a transmitter and a receiver, where the transmitter and receiver share a rank indicator, a precoding matrix indicator, and channel quality information.

FIG. 3 is a diagram illustrating an example of a transmitter and a receiver that share a first precoding matrix indicator, a second precoding matrix indictor, and channel quality information.

FIG. 4 is a diagram illustrating an example of a transmitter and a receiver that share a first precoding matrix indicator, a second precoding matrix indicator, channel quality information, and differential information.

FIG. 5 is a diagram illustrating an example of a communication apparatus.

Throughout the drawings and the detailed description, unless otherwise described, the same drawing reference numerals should be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, description of well-known functions and constructions may be omitted for increased clarity and conciseness.

Hereinafter, certain examples will be described in detail with reference to the accompanying drawings.

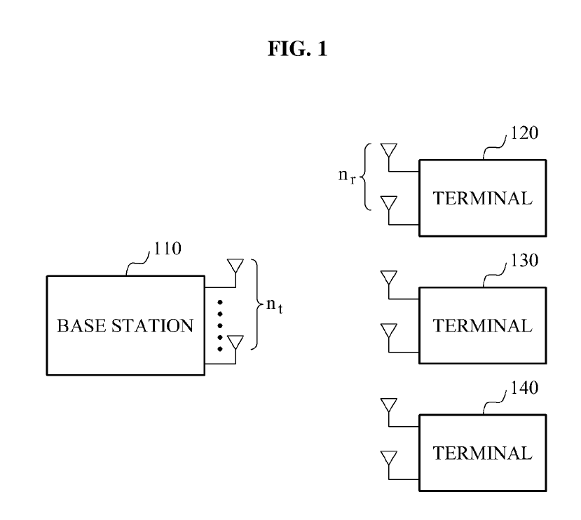

FIG. 1 illustrates an example of a multi-user multiple input multiple output (MIMO) communication system.

Referring to FIG. 1, the multi-user MIMO communication system may include a base station 110 and a plurality of terminals 120, 130, and 140. In a downlink communication, the base station may operate as a transmitter, and each of the terminals 120, 130, and 140 may operate as a receiver. In an uplink communication, the base station 110 may operate as the receiver, and each of the terminals 120, 130, and 140 may operate as the transmitter.

Hereinafter, examples will be described with respect to the base station 110 and the plurality of terminals 120, 130, and 140 operating in downlink communication. The examples may also be applicable to uplink communication.

The base station 110 may have a plurality of antennas, for example, two antennas, four antennas, eight antennas, and the like, may precode data streams to transmit data in the downlink. The base station 110 may verify information associated with channels formed between antennas of the base station 110 and antennas of each of the terminals 120, 130, and 140. For example, since the base station 110 and the terminals 120, 130, and 140 may share information associated with the channels, the terminals 120, 130, and 140 may feed back information associated with the channels to the base station 110.

Information associated with the channels may include a precoding matrix indicator, channel quality information, and the like. The same codebook including a predetermined number of matrices or vectors may be stored in the base station 110 and each of the terminals 120, 130, and 140. Each of the terminals 120, 130, and 140 may select a single matrix or vector from the codebook and generate the precoding matrix indicator accordingly. For example, an index of the selected single matrix or vector may be the precoding matrix indicator. The channel quality indicator may include information associated with strengths of channels, information associated with interference or noise affecting the channels, and the like.

The codebook may have a variety of sizes, for example, two bits, three bits, four bits, five bits, six bits, and the like. For example, a four-bit codebook may include 2⁴=16 vectors or matrices. Since a vector is a matrix having only a single column, the term ‘matrix’ should be understood to include the concept of the ‘vector’.

Hereinafter, a method of sharing the precoding matrix indicator, the channel quality information, the rank indicator, and the like between the base station 110 and the terminals 120, 130, and 140 will be described with reference to various examples.

According to certain examples, two different codebooks C₁ and C₂ may be used. For example, the two codebooks C₁ and C₂ may be stored in each of the terminals 120, 130, and 140. In this example, each of the terminals 120, 130, and 140 may select a preferred precoding matrix W₁ from the codebook C₁, and may select a preferred precoding matrix W₂ from another codebook C₂. An index of W₁ and an index of W₂ may each correspond to precoding matrix indicators. Here, W₁ corresponds to an element of C₁ and W₂ corresponds to an element of C₂.

When a plurality of subbands is present in a frequency domain, a precoding matrix W with respect to a single subband substantially used by the base station 110 may correspond to a function of W₁ and W₂. As an example, W₁ may be associated with a wideband channel property or a long term channel property, and W₂ may be associated with a frequency-selective channel property or a short term channel property.

Channel quality information (CQI), a precoding matrix indicator (PMI), a rank indicator (RI), and the like may be transmitted and received via one of a physical uplink shared channel (PUSCH) and a physical uplink control channel (PUCCH).

Aperiodic CQI/PMI/RI Reporting Using PUSCH

A terminal may feed back channel quality information, a precoding matrix indicator, and a rank indicator via a PUSCH. A variety of reporting modes may be used by the terminal, such as the examples shown in Table 1.

TABLE 1

| | | PMI Feedback Type | | |
|---|---|---|---|---|
| | | No | Single | Multiple |
| | | PMI | PMI | PMI |
| PUSCH CQI | Wideband | | | Mode 1-2 |
| Feedback Type | (wideband CQI) | | | Mode 1-2.1 |
| | UE Selected | Mode 2-0 | | Mode 2-2 |
| | (subband CQI) | | | Mode 2-2.1 |
| | Higher | Mode 3-0 | Mode 3-1 | |
| | Layer-configured | | | |
| | (subband CQI) | | | |

Reporting modes to be applied may vary depending on transmission modes. For example, when seven transmission modes 1, 2, 3, 4, 5, 6, and 7 are present, reporting modes applied to each of the transmission modes 1, 2, 3, 4, 5, 6, and 7 may be expressed as shown below.

Transmission mode 1: Reporting modes 2-0, 3-0

Transmission mode 2: Reporting modes 2-0, 3-0

Transmission mode 3: Reporting modes 2-0, 3-0

Transmission mode 4: Reporting modes 1-2, 2-2, 3-1

Transmission mode 5: Reporting mode 3-1

Transmission mode 6: Reporting modes 1-2, 2-2, 3-1

Transmission mode 7: Reporting modes 2-0, 3-0

In addition to the aforementioned transmission modes 1, 2, 3, 4, 5, 6, and 7, a transmission mode 8 may be included to support reporting modes 1-2, 2-2, and 3-1 when a terminal accompanies PMI and RI reporting, and to support reporting modes 2-0 and 3-0 when the terminal does not accompany PMI and RI reporting.

Furthermore, a transmission mode 9 may be included. The transmission mode 9 may support at least one of the reporting modes shown in Table 1. In the transmission mode 9, the reporting modes recited in Table 1 may be used even when a number of transmit antennas is a predetermined number, for example, 2, 4, 8, and the like.

In the transmission mode 8 and the transmission mode 9, when the terminal accompanies PMI and RI reporting, reporting modes 1-2, 2-2, 3-1, 1-2.1, and 2-2.1 may be used. The modes may correspond to revised versions of reporting modes 1-2, 2-2, and 3-1, and may be applicable to an example where four transmit antennas are present, and to an example where eight transmit antennas are present. If the terminal does not accompany PMI and RI reporting, reporting modes 2-0 and 3-0 may be used.

The reporting modes, for example, reporting modes 1-2.1, 2-2.1, and 3-1.1, may have the following implementation:

Every time a wideband matrix indicator is applied to reduce feedback overhead or to report an appropriate precoding matrix with respect to an assignment of a large resource block, a precoding matrix indicator of W₁ may be generated. Every time a wideband matrix indicator having a relatively high accuracy is applied, an additional precoding matrix indicator of W₂ may be generated in a wideband scheme.

Every time a subband matrix indicator is applied, an additional precoding matrix indicator of W₂ may be generated.

According to reporting modes, a single subband precoding matrix indicator may be determined in a set of a plurality of subbands or in an individual subband. CQI may be determined based on a recommended precoding matrix W. The recommended precoding matrix W may correspond to a function of W₁ and W₂. When W₂ is reported with respect to all subbands, or when W₂ is reported with respect to a set of subbands, wideband CQI may be determined based on W. As another example, the wideband CQI may be determined based on W that is the function of W₁ and W₂. Subband CQI may be determined in a single subband, or may be determined in a subset of a set of the plurality of subbands. The subband CQI may be determined in the subbands based on W, that is, a function of W₁ and W₂.

1. Wideband Feedback

(1) Reporting Mode 1-2:

When transmitting only in a subband, with respect to each subband, a precoding matrix indicator of a first precoding matrix W₁ may be generated from a first codebook C₁.

A terminal may feed back one wideband CQI per codeword. The corresponding wideband CQI may be determined when transmitting in a set of subbands if a corresponding precoding matrix W is applied in each subband.

The terminal may feed back a selected precoding matrix indicator with respect to each subband. Further, a size of each subband may be determined according to various methods known in the art or specifically designed for the examples described herein.

With respect to transmission mode 8 or transmission mode 9, the precoding matrix indicator and CQI may be determined based on a reported rank indicator. The first codebook C₁ and a second codebook C₂ may correspond to subsets of the same codebook C.

(2) Reporting Mode 1-2.1:

When transmitting in a set of subbands, a first precoding matrix indicator with respect to a set of subbands of a first precoding matrix W₁ may be generated from a first codebook C₁.

When transmitting only in a selected subband, with respect to each subband, a second precoding matrix indicator of a second precoding matrix W₂ may be generated from a second codebook C₂. In particular, transmission may be performed based on W, that is, a function of W₁ and W₂.

The terminal may report one wideband CQI per codeword. The corresponding wideband CQI may be determined when transmitting in a set of subbands if a corresponding precoding matrix W is applied in each subband. Further, the terminal may report a second precoding matrix index with respect to each subband.

In reporting mode 1-2.1, a precoding matrix indicator and CQI may be determined based on a reported rank indicator, and a size of a subband may be determined according to various methods known in the art or specifically designed for the examples described herein.

2. Subband Feedback in Upper Layer

(1) Reporting Mode 3-1:

When transmitting in a set of subbands, a first precoding matrix indicator of a single first precoding matrix W₁ may be generated from a first codebook C₁. When transmitting in the set of the subbands, a second precoding matrix indicator of a single second precoding matrix W₂ may be generated from a second codebook C₂.
A terminal may report one subband CQI per codeword, with respect to each subband. The corresponding subband CQI may be determined when transmitting in a corresponding subband if W (that is, a function of W₁ and W₂) is applied in all subbands.

The terminal may report one wideband CQI per codeword. The corresponding wideband CQI may be determined when transmitting in the set of subbands if W (that is, the function of W₁ and W₂) is applied in all of the subbands.

With respect to transmission mode 8 and transmission mode 9, a precoding matrix indicator and CQI may be determined based on a reported rank indicator.

(2) Information associated with a difference, that is, differential information between CQI with respect to a set of a plurality of subbands and subband CQI with respect to each codeword, may be encoded using two bits.

(3) A size of a subband may be determined according to various methods known in the art or specifically designed for the examples described herein.

3. UE-Selected Subband Feedback

(1) Reporting Mode 2-2:

When transmitting in a set of subbands, a first precoding matrix indicator of a single first precoding matrix W₁ may be generated from a first codebook C₁.

A terminal may report one subband CQI per codeword, with respect to each subband. The corresponding subband CQI may be determined when transmitting in the set of subbands if W (that is, a function of W₁ and W₂) is applied in all of the subbands.

The terminal may report the first precoding matrix indicator of the single first precoding matrix W₁ with respect to the set of subbands. The terminal may perform a joint selection of a first precoding matrix selected from a first codebook and a subset of M preferred subbands having a size k within the set of subbands. The first precoding matrix may correspond to a precoding matrix used for transmission in M selected subbands.

The terminal may report one CQI based on transmission in M preferred subbands and the same single precoding matrix in each of M subbands. The terminal may also report the first precoding matrix indicator of the selected single first precoding matrix with respect to M selected subbands.

With respect to transmission mode 8 and transmission mode 9, a precoding matrix indicator and CQI may be determined based on a reported rank indicator.

(2) Reporting Mode 2-2.1:

When transmitting in a set of subbands, a first precoding matrix indicator of a single first precoding matrix W₁ may be generated from a first codebook C₁.

A terminal may report one wideband CQI per codeword. The corresponding wideband CQI may be determined when transmitting in the set of subbands if the single first precoding matrix W₁ is applied in all subbands.

The terminal may report the first precoding matrix indicator of the single first precoding matrix W₁ with respect to the set of subbands. The terminal may perform a joint selection of a second precoding matrix W₂ selected from a second codebook and a subset of M preferred subbands having a size k within the set of subbands. The precoding matrix W may correspond to a function of W₁ and W₂, and may also correspond to a precoding matrix used for transmission in M selected subbands.

When transmitting only in M selected subbands and if the same single precoding matrix W is used in each of M subbands, the terminal may report one wideband CQI. The terminal may also report a single second precoding matrix indicator with respect to M subbands.

With respect to transmission mode 8 and transmission mode 9, a precoding matrix indicator and CQI may be determined based on a reported rank indicator.

With respect to the UE selected subband feedback modes, the terminal may report information regarding M selected subbands.

Differential information, between CQI with respect to M selected subbands for each codeword and wideband CQI, may be encoded using two bits. An indicator indicating positions of M subbands may be encoded using L bits.

Periodic CQI/PMI/RI Reporting Using PUCCH

A terminal may feed back differential information, for example, differential CQI, a precoding matrix indicator, and a rank indicator via a PUCCH. A variety of reporting modes may be used by the terminal, such as the examples shown in Table 2.

TABLE 2

| | | PMI Feedback Type | | |
|---|---|---|---|---|
| | | No | Single | Multiple |
| | | PMI | PMI | PMI |
| PUSCH CQI | Wideband | Mode 1-0 | Mode 1-1 | NA |
| Feedback Type | (wideband CQI) | | | |
| | UE Selected | Mode 2-0 | Mode 2-1 | Mode 2-2.0 |
| | (subband CQI) | | | Mode 2-2.1 |

Reporting modes 1-0, 1-1, 2-0, and 2-1 disclosed in Table 2 are well described in 3^{rd} Generation Partnership Project (3GPP) Long Term Evolution (LTE) Rel. 8 TS 36.213. New reporting modes may be proposed as reporting modes 2-2.0 and 2-2.1, which are further described herein.

Reporting modes to be applied may vary depending on transmission modes. For example, when seven transmission modes 1, 2, 3, 4, 5, 6, and 7 are present, reporting modes applied to each of the transmission modes 1, 2, 3, 4, 5, 6, and 7 may be expressed as shown below.

Transmission mode 1: Reporting modes 1-0, 2-0

Transmission mode 2: Reporting modes 1-0, 2-0

Transmission mode 3: Reporting modes 1-0, 2-0

Transmission mode 4: Reporting modes 1-1, 2-1

Transmission mode 5: Reporting modes 1-1, 2-1

Transmission mode 6: Reporting modes 1-1, 2-1

Transmission mode 7: Reporting modes 1-0, 2-0

In addition to the aforementioned transmission modes 1, 2, 3, 4, 5, 6, and 7, transmission mode 8 may be included to support reporting modes 1-1 and 2-1 when a terminal accompanies PMI and RI reporting, and to support reporting modes 1-0 and 2-0 when the terminal does not accompany PMI and RI reporting.

Furthermore, a transmission mode 9 may be included. The transmission mode 9 may support at least one of the reporting modes shown in Table 2. In the transmission mode 9, the reporting modes recited in Table 2 may be used even when a number of transmit antennas is a predetermined number, for example, 2, 4, 8, and the like.

The reporting modes may be categorized based on criteria such as i) ‘non-subband report/subband report’ and ii) ‘W₁ and W₂ reported in different subframes/W₁ and W₂ reported in the same subframe’. An additional category may be provided by employing W₂ as wideband information or subband information. When W₂ is used as the wideband information, W₂ may be expressed as W₂_{_{—}}_{W}. When W₂ is used as the subband information, W₂ may be expressed as W₂_{_{—}}_{S}. In addition, A∥B indicates that information A and information B are reported in different subbands.

As described above, new reporting modes may be proposed as reporting modes 2-2.0 and 2-2.1.

1) Reporting Mode RI, W₁∥W₂_{_{—}}_{W}, CQI_{—}W

A rank indicator and a precoding matrix indicator of W₁ may be reported in the same subframe. The rank indicator and the precoding matrix indicator of W₁ may be jointly or separately encoded. W₁ may be selected from a first codebook C₁ or a subset of the first codebook C₁.

When a subset with respect to a second codebook includes only a single element, one-to-one mapping between W₁ and W₂_{_{—}}_{W} may be established. Accordingly, a precoding matrix indicator of W₂_{_{—}}_{W} may not be explicitly signaled.

Wideband CQI_{—}W may be determined if a precoding matrix is a function of W₁ and W₂_{_{—}}_{W}. A precoding matrix indicator of W₂_{_{—}}_{W} and wideband CQI_{—}W may be jointly encoded and reported in the same subframe.

Since W₂_{_{—}}_{W} is present in the second codebook C₂ or in the subset of the second codebook C₂, feedback accuracy may increase. In particular, when a PUCCH power control is applied, and when an energy constraint is applied, error propagation may be mitigated.

An indicator corresponding to a precoding matrix selected from the first codebook may be referred to as the first precoding matrix indicator, and an indicator corresponding to a precoding matrix selected from the second codebook may be referred to as the second precoding matrix indicator. The precoding matrix selected from the first codebook may be expressed as W₁, and the precoding matrix selected from the second codebook may be expressed as W₂_{_{—}}_{W} or W₂_{_{—}}_{S}.

2) Reporting Mode RI∥W₁∥W₂_{_{—}}_{W}, CQI_{—}W

A rank indicator and a precoding matrix indicator of W₁ may be reported in different subframes. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or from a subset of the second codebook.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

Wideband CQI_{—}W may be determined if a precoding matrix is a function of W₁ and W₂_{_{—}}_{W}. A precoding matrix indicator of W₂_{_{—}}_{W} and wideband CQI_{—}W may be jointly encoded and reported in the same subframe.

The ‘rank indicator’, the ‘precoding matrix indicator of W₁’, and the ‘precoding matrix indicator of W₂_{_{—}}_{W} and CQI_{—}W’ may be reported in three different subframes.

Since W₂_{_{—}}_{W} is present in the second codebook C₂ or in the subset of the second codebook C₂, feedback accuracy may increase.

3) Reporting Mode RI∥W₁, W₂_{_{—}}_{W}∥CQI_{—}W

A rank indicator and a precoding matrix indicator of W₁ may be reported in different subframes. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or from a subset of the second codebook. The precoding matrix indicator of W₁ and a precoding matrix indicator of W₂_{_{—}}_{W} may be jointly encoded and reported in the same subframe.

When the subset with respect to the second codebook includes only a single element, one-to-one mapping between W₁ and W₂_{_{—}}_{W} may be established. Accordingly, the precoding matrix indicator of W₂_{_{—}}_{W} may not be explicitly signaled.

Wideband CQI_{—}W may be determined if a precoding matrix is a function of W₁ and W₂_{_{—}}_{W}.

The ‘rank indicator’, the ‘precoding matrix indicator of W₁ and the precoding matrix indicator of W₂_{_{—}}_{W}’, and ‘CQI_{—}W’ may be reported in three different subframes.

4) Reporting Mode RI∥W₁, W₂_{_{—}}_{W}, CQI_{—}W

A rank indicator and a precoding matrix indicator of W₁ may be reported in different subframes. W₁ may be selected from a first codebook C₁ or a subset of the first codebook C₁.

W₂_{_{—}}_{W} may be selected from the whole band, and W₂_{_{—}}_{W} may be selected from a second codebook or from a subset of the second codebook. The precoding matrix indicator of W₁, the precoding matrix indicator of W₂_{_{—}}_{W}, and CQI_{—}W may be jointly encoded and reported in the same subframe.

When the subset with respect to the second codebook includes only a single element, one-to-one mapping between W₁ and W₂_{_{—}}_{W} may be established. Accordingly, the precoding matrix indicator of W₂_{_{—}}_{W} may not be explicitly signaled.

Wideband CQI_{—}W may be determined if a precoding matrix is a function of W₁ and W₂_{_{—}}_{W}.

The ‘rank indicator’ and the ‘precoding matrix indicator of W₁, the precoding matrix indicator of W_{2w}, and CQI_{—}W’ may be reported in two different subframes.

5) Reporting Mode RI, W₁, W₂_{_{—}}_{W}∥CQI_{—}W

A rank indicator, a precoding matrix indicator of W₁, and a precoding matrix indicator of W₂_{_{—}}_{W} may be jointly encoded and reported in the same subframe. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or from a subset of the second codebook.

When the subset with respect to the second codebook includes only a single element, one-to-one mapping between W₁ and W₂_{_{—}}_{W} may be established. Accordingly, the precoding matrix indicator of W₂_{_{—}}_{W} may not be explicitly signaled.

Wideband CQI_{—}W may be determined if a precoding matrix is a function of W₁ and W₂_{_{—}}_{W}.

The ‘rank indicator, the precoding matrix indicator of W₁, and the precoding matrix indicator of W₂_{_{—}}_{W}’, and ‘CQI_{—}W’ may be reported in two different subframes.

6) Reporting Mode RI, W₁∥W₂_{_{—}}_{W}, CQI_{—}W∥CQI_S

A rank indicator and a precoding matrix indicator of W₁ may be reported in the same subframe, and may be jointly or individually be encoded. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

Wideband CQI_{—}W may be determined if a precoding matrix is a function of W₁ and W₂_{_{—}}_{W}. A precoding matrix indicator of W₂_{_{—}}_{W} and wideband CQI_{—}W may be jointly encoded and reported in the same subframe.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{W} in a subband.

The ‘rank indicator and the precoding matrix indicator of W₁’, the ‘precoding matrix indicator of W₂_{_{—}}_{W} and CQI_{—}W’, and ‘CQI_{—}S’ may be reported in three different subframes.

7) Reporting Mode RI∥W₁∥W₂_{_{—}}_{W}, CQI_{—}W∥CQI_{—}S

A rank indicator and a precoding matrix indicator of W₁ may be reported in the same subframe. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

Wideband CQI_{—}W may be determined if a precoding matrix is a function of W₁ and W₂_{_{—}}_{W}. The precoding matrix indicator of W₂_{_{—}}_{W} and wideband CQI_{—}W may be jointly encoded and reported in the same subframe.

CQI_{—}S may refer to subband CQI, and CQI_{—}S may be obtained from a single subband. As an example, CQI_{—}S may selected from a bandwidth portion. CQI_{—}S may be determined if a precoding matrix is a function of W₁ and W₂_{_{—}}_{W} in a subband.

The ‘rank indicator’, the ‘precoding matrix indicator of W₁’, the ‘precoding matrix indicator of W₂_{_{—}}_{W} and CQI_{—}W’, and ‘CQI_{—}S’ may be reported in four different subframes.

8) Reporting Mode RI∥W₁, CQI_{—}W II W₂_{_{—}}_{W}, CQI_{—}S

A rank indicator and a precoding matrix indicator of W₁ may be reported in different subframes. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

Wideband CQI_{—}W may be determined if a precoding matrix is a function of only W₁. That is, when W₁ is selected, W₂ is predetermined. Accordingly, W₂ may be predefined as, for example, an identity matrix. The precoding matrix indicator of W₁ and wideband CQI_{—}W may be jointly encoded and reported in the same subframe.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{W} in a subband. The precoding matrix indicator of W₂_{_{—}}_{W} and wideband CQI_{—}S may be jointly encoded and reported in the same subframe.

The ‘rank indicator’, the ‘precoding matrix indicator of W₁ and CQI_{—}W’, and the ‘precoding matrix indicator of W₂_{_{—}}_{W}, CQI_{—}S’ may be reported in three different subframes.

9) Reporting Mode RI, W₁∥W₂_{_{—}}_{W}, CQI_{—}W∥W₂_{_{—}}_{S}, CQI_{—}S

A rank indicator and a precoding matrix indicator of W₁ may be reported in the same subframe. The rank indicator and the precoding matrix indicator of W₁ may be jointly or separately encoded. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook.

When the subset with respect to the second codebook includes only a single element, one-to-one mapping between W₁ and W₂_{_{—}}_{W} may be established. Accordingly, the precoding matrix indicator of W₂_{_{—}}_{W} may not be explicitly signaled.

W₂_{_{—}}_{S} may correspond to W₂ selected from a single subband, and W₂_{_{—}}_{S} may be selected from the second codebook or the subset of the second codebook.

Wideband CQI_{—}W may be determined if a precoding matrix is a function of W₁ and W₂_{_{—}}_{W}. A precoding matrix indicator of W₂_{_{—}}_{W} and wideband CQI_{—}W may be jointly encoded and reported in the same subframe.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{S} in a subband. The precoding matrix indicator of W₂_{_{—}}_{S} and CQI_{—}S may be jointly encoded and reported in the same subframe.

The ‘rank indicator and the precoding matrix indicator of W₁’, the ‘precoding matrix indicator of W₂_{_{—}}_{W} and CQI_{—}W’, and the ‘precoding matrix indicator of W₂_{_{—}}_{S} and CQI_{—}S’ may be reported in three different subframes.

10) Reporting Mode RI∥W₁∥W₂_{_{—}}_{W}, CQI_{—}W∥W₂_{_{—}}_{S}, CQI_{—}S

A rank indicator and a precoding matrix indicator of W₁ may be reported in different subframes. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

W₂_{_{—}}_{S} may correspond to W₂ selected from the whole band, and W₂_{_{—}}_{S} may be selected from a second codebook or a subset of the second codebook.

Wideband CQI_{—}W may be determined if a precoding matrix is a function of W₁ and W₂_{_{—}}_{W}. A precoding matrix of W₂_{_{—}}_{W} and wideband CQI_{—}W may be jointly encoded and reported in the same subframe.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{S} in a subband. A precoding matrix of W₂_{_{—}}_{S} and wideband CQI_{—}S may be jointly encoded and reported in the same subframe.

The ‘rank indicator’, the ‘precoding matrix indicator of W₁’, the ‘precoding matrix indicator of W₂_{_{—}}_{W} and CQI_{—}W’, and the ‘precoding matrix indicator of W₂_{_{—}}_{S} and CQI_{—}S’ may be reported in four different subframes.

11) Reporting Mode RI∥W₁, W₂_{_{—}}_{W}, CQI_{—}W∥W₂_{_{—}}_{S}, CQI_{—}S

A rank indicator and a precoding matrix indicator of W₁ may be reported in different subframes. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook. The precoding matrix indicator of W₁, a precoding matrix indicator of W₂_{_{—}}_{W}, and wideband CQI_{—}W may be jointly encoded and reported in the same subframe.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

W₂_{_{—}}_{S} may correspond to W₂ selected from the whole band, and W₂_{_{—}}_{S} may be selected from a second codebook or a subset of the second codebook.

Wideband CQI_{—}W may be determined if a precoding matrix is a function of W₁ and W₂_{_{—}}_{W}.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{S} in a subband. The precoding matrix indicator of W₂_{_{—}}_{S} and CQI_{—}S may be jointly encoded and reported in the same subframe.

The ‘rank indicator’, the ‘precoding matrix indicator of W₁, the precoding matrix indicator of W₂_{_{—}}_{W}, and CQI_{—}W’, and the ‘precoding matrix indicator of W₂_{_{—}}_{S} and CQI_{—}S’ may be reported in three different subframes.

12) Reporting Mode RI∥W₁, CQI_{—}W∥W₂_{_{—}}_{S}, CQI_{—}S

A rank indicator and a precoding matrix indicator of W₁ may be reported in different subframes. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook. The precoding matrix indicator of W₁ and CQI_{—}W may be jointly encoded and reported in the same subframe.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

W₂_{_{—}}_{S} may correspond to W₂ selected from a single subband, and W₂_{_{—}}_{S} may be selected from the second codebook or the subset of the second codebook.

Wideband CQI_{—}W may be determined if a precoding matrix is a function of only W₁. That is, when W₁ is selected, W₂ is predetermined. Accordingly, W₂ may be predefined as, for example, an identity matrix. The precoding matrix indicator of W₁ and wideband CQI_{—}W may be jointly encoded and reported in the same subframe.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{W} in a subband. The precoding matrix indicator of W₂_{_{—}}_{S} and CQI_{—}S may be jointly encoded and reported in the same subframe.

The ‘rank indicator’, the ‘precoding matrix indicator of W₁ and CQI_{—}W’, and the ‘precoding matrix indicator of W₂_{_{—}}_{S} and CQI_{—}S’ may be reported in three different subframes.

13) Reporting Mode RI∥W₁, W₂_{_{—}}_{W}∥CQI_{—}W∥CQI_{—}S

A rank indicator and a precoding matrix indicator of W₁ may be reported in different subframes. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook. The precoding matrix indicator of W₁ and a precoding matrix indicator of W₂_{_{—}}_{W} may be reported in the same subframe.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

Wideband CQI_{—}W may be determined if a precoding matrix is a function of W₁ and W₂_{_{—}}_{W}.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{W} in a subband.

The ‘rank indicator’, the ‘precoding matrix indicator of W₁ and the precoding matrix indicator of W₂_{_{—}}_{W}’, ‘CQI_{—}W’, and ‘CQI_{—}S’ may be reported in four different subframes.

14) Reporting Mode RI∥W₁, W₂_{_{—}}_{W}, CQI_{—}W∥CQI_{—}S

A rank indicator and a precoding matrix indicator of W₁ may be reported in different subframes. W₁ may be selected from a codebook C₁ or a subset of the first codebook.

W₂_{_{—}}_{W} may correspond to W₂ selected from the whole band, and W₂_{_{—}}_{W} may be selected from a second codebook or a subset of the second codebook. The precoding matrix indicator of W₁, a precoding matrix indicator of W₂_{_{—}}_{W}, and CQI_{—}W may be jointly encoded and reported in the same subframe.

When the subset with respect to the second codebook includes only a single element, one-to-one mapping between W₁ and W₂_{_{—}}_{W} may be established. Accordingly, a precoding matrix indicator of W₂_{_{—}}_{W} may not be explicitly signaled.

Wideband CQI_{—}W may be determined if a precoding matrix is a function of W₁ and W₂_{_{—}}_{W}.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{S} in a subband.

The ‘rank indicator’, the ‘precoding matrix indicator of W₁, the precoding matrix indicator of W₂_{_{—}}_{W}, and CQI_{—}W’, and ‘CQI_{—}S’ may be reported in three different subframes.

15) Reporting Mode RI, W₁, W₂_{_{—}}_{W}∥CQI_{—}W∥CQI_{—}S

A rank indicator, a precoding matrix indicator of W₁, and a precoding matrix indicator W₂_{_{—}}_{W} may be jointly encoded and reported in the same subframe. W₁ may be selected from a first codebook C₁ or a subset of the first codebook C₁.

W₂_{_{—}}_{W} may correspond to W₂ selected from the whole band, and W₂_{_{—}}_{W} may be selected from a second codebook or a subset of the second codebook.

When the subset with respect to the second codebook includes only a single element, one-to-one mapping between W₁ and W₂_{_{—}}_{W} may be established. Accordingly, the precoding matrix indicator of W₂_{_{—}}_{W} may not be explicitly signaled.

Wideband CQI_{—}W may be determined if a precoding matrix is a function of W₁ and W₂_{_{—}}_{W}.

CQI_{—}S may refer to subband CQI, and CQI_{—}S may be obtained from a single subband. As an example, CQI_{—}S may be selected from a bandwidth portion. CQI_{—}S may be determined if a precoding matrix is a function of W₁ and W₂_{_{—}}_{S} in a subband.

The ‘rank indicator, the precoding matrix indicator of W₁, and the precoding matrix indicator of W₂_{_{—}}_{W}’, ‘CQI_{—}W’, and ‘CQI_{—}S’ may be reported in three different subframes.

Reporting Types

Five CQI/PMI and RI reporting types, having distinct periods and offsets, may be supported for each PUCCH reporting mode, as shown in Table 3.

Type 1 report supports CQI feedback with respect to UE selected subbands.

Type 2 report supports wideband CQI and PMI feedback.

Type 3 report supports RI feedback.

Type 4 report supports wideband CQI.

Type 5 report supports CQI and PMI with respect to UE selected subbands. Further, Type 5 enables reporting of subband or wideband different MPI and subband CQI. In this example, two options may be provided: Type 5.0, including Subband (differential) PMI and subband CQI, and Type 5.1, including Wideband (differential) PMI and subband CQI.

TABLE 3

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | Subband | RI = 1 | NA | NA | NA | NA | 4 + L + 2 |
| | CQI/subband | RI > 1 | NA | NA | NA | NA | 7 + L + 2 |
| | PMI | | | | | | |
| 5.1 | Subband | RI = 1 | NA | NA | NA | NA | 4 + L + 2 |
| | CQI/wideband | RI > 1 | NA | NA | NA | NA | 7 + L + 2 |
| | PMI | | | | | | |

Table 3 may be applied to a two-bit subband PMI, as shown in Table 4, Table 5, and Table 6.

TABLE 4

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | 5.0: Subband | 2 TX Antennas RI = 1 | NA | NA | NA | NA | NA |
| 5.1 | CQI/subband | 4 TX Antennas RI = 1 | NA | NA | NA | NA | 4 + L + 2 |
| | PMI | 8 TX Antennas RI = 1 | NA | NA | NA | NA | 4 + L + 2 |
| | 5.1: Subband | 2 TX Antennas RI > 1 | NA | NA | NA | NA | NA |
| | CQI/wideband | 4 TX Antennas RI > 1 | NA | NA | NA | NA | 7 + L + 2 |
| | PMI | 8 TX Antennas RI > 1 | NA | NA | NA | NA | 7 + L + 2 |

TABLE 5

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | 5.0: Subband | 2 TX Antennas RI = 1 | NA | NA | NA | NA | NA |
| 5.1 | CQI/subband | 4 TX Antennas RI = 1 | NA | NA | NA | NA | 4 + L + 2 |
| | PMI | 8 TX Antennas RI = 1 | NA | NA | NA | NA | 4 + L + 2 |
| | 5.1: Subband | 2 TX Antennas RI = 2 | NA | NA | NA | NA | NA |
| | CQI/wideband | 4 TX Antennas RI = 2 | NA | NA | NA | NA | 7 + L + 2 |
| | PMI | 8 TX Antennas RI = 2 | NA | NA | NA | NA | 7 + L + 2 |
| | | 2 TX Antennas RI > 2 | NA | NA | NA | NA | NA |
| | | 4 TX Antennas RI > 2 | NA | NA | NA | NA | 7 + L |
| | | 8 TX Antennas RI > 2 | NA | NA | NA | NA | 7 + L |

TABLE 6

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | 5.0: Subband | 2 TX Antennas RI = 1 | NA | NA | NA | NA | NA |
| 5.1 | CQI/subband | 4 TX Antennas RI = 1 | NA | NA | NA | NA | 2 + L + X |
| | PMI | 8 TX Antennas RI = 1 | NA | NA | NA | NA | 2 + L + X |
| | 5.1: Subband | 2 TX Antennas RI = 2 | NA | NA | NA | NA | NA |
| | CQI/wideband | 4 TX Antennas RI = 2 | NA | NA | NA | NA | 4 + L + X |
| | PMI | 8 TX Antennas RI = 2 | NA | NA | NA | NA | 4 + L + X |
| | | 2 TX Antennas RI > 2 | NA | NA | NA | NA | NA |
| | | 4 TX Antennas RI > 2 | NA | NA | NA | NA | 7 + L |
| | | 8 TX Antennas RI > 2 | NA | NA | NA | NA | 7 + L |

Table 3 may be further applied to a Y-bit subband PMI, as shown in Table 7, Table 8, and Table 10.

TABLE 7

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | 5.0: Subband | RI = 1 | NA | NA | NA | NA | 4 + L + X |
| 5.1 | CQI/subband | RI > 1 | NA | NA | NA | NA | 7 + L + Y |
| | PMI | | | | | | |
| | 5.1: Subband | | | | | | |
| | CQI/wideband | | | | | | |
| | PMI | | | | | | |

TABLE 8

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | 5.0: Subband | 2 TX Antennas RI = 1 | NA | NA | NA | NA | NA |
| 5.1 | CQI/subband | 4 TX Antennas RI = 1 | NA | NA | NA | NA | 4 + L + X |
| | PMI | 8 TX Antennas RI = 1 | NA | NA | NA | NA | 4 + L + X |
| | 5.1: Subband | 2 TX Antennas RI > 1 | NA | NA | NA | NA | NA |
| | CQI/wideband | 4 TX Antennas RI > 1 | NA | NA | NA | NA | 7 + L + Y |
| | PMI | 8 TX Antennas RI > 1 | NA | NA | NA | NA | (=7 + L + 2) |
| | | | | | | | 7 + L + Y |
| | | | | | | | (=7 + L + 2) |

TABLE 9

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | 5.0: Subband | 2 TX Antennas RI = 1 | NA | NA | NA | NA | NA |
| 5.1 | CQI/subband | 4 TX Antennas RI = 1 | NA | NA | NA | NA | 4 + L + X |
| | PMI | 8 TX Antennas RI = 1 | NA | NA | NA | NA | 4 + L + X |
| | 5.1: Subband | 2 TX Antennas RI = 2 | NA | NA | NA | NA | NA |
| | CQI/wideband | 4 TX Antennas RI = 2 | NA | NA | NA | NA | 7 + L + Y |
| | PMI | 8 TX Antennas RI = 2 | NA | NA | NA | NA | (=7 + L + 2) |
| | | 2 TX Antennas RI > 2 | NA | NA | NA | NA | 7 + L + Y |
| | | 4 TX Antennas RI > 2 | NA | NA | NA | NA | (=7 + L + 2) |
| | | 8 TX Antennas RI > 2 | NA | NA | NA | NA | NA |
| | | | | | | | 7 + L |
| | | | | | | | 7 + L |

TABLE 10

| | | | PUCCH Reporting Modes | | | | |
|---|---|---|---|---|---|---|---|
| PUCCH | | | | | | | Mode 2-2.0 |
| Report | | | Mode 1-1 | Mode 2-1 | Mode 1-0 | Mode 2-0 | Mode 2-2.1 |
| Type | Reported | Mode State | (bits/BP) | (bits/BP) | (bits/BP) | (bits/BP) | (bits/BP) |
| 1 | Subband | RI = 1 | NA | 4 + L | NA | 4 + L | NA |
| | CQI | RI > 1 | NA | 7 + L | NA | 4 + L | NA |
| 2 | Wideband | 2 TX Antennas RI = 1 | 6 | 6 | NA | NA | 6 |
| | CQI/PMI | 4 TX Antennas RI = 1 | 8 | 8 | NA | NA | 8 |
| | | 8 TX Antennas RI = 1 | 8 | 8 | NA | NA | 8 |
| | | 2 TX Antennas RI > 1 | 8 | 8 | NA | NA | 8 |
| | | 4 TX Antennas RI > 1 | 11 | 11 | NA | NA | 11 |
| | | 8 TX Antennas RI > 1 | 11 | 11 | NA | NA | 11 |
| 3 | RI | 2-layer spatial multiplexing | 1 | 1 | 1 | 1 | 1 |
| | | 4-layer spatial multiplexing | 2 | 2 | 2 | 2 | 2 |
| | | 8-layer spatial multiplexing | 3 | 3 | 3 | 3 | 3 |
| 4 | Wideband | RI = 1 or RI > 1 | NA | NA | 4 | 4 | NA |
| | CQI | | | | | | |
| 5.0 | 5.0: Subband | 2 TX Antennas RI = 1 | NA | NA | NA | NA | NA |
| 5.1 | CQI/subband | 4 TX Antennas RI = 1 | NA | NA | NA | NA | 2 + L + X |
| | PMI | 8 TX Antennas RI = 1 | NA | NA | NA | NA | 2 + L + X |
| | 5.1: Subband | 2 TX Antennas RI = 2 | NA | NA | NA | NA | NA |
| | CQI/wideband | 4 TX Antennas RI = 2 | NA | NA | NA | NA | 4 + L + Y |
| | PMI | 8 TX Antennas RI = 2 | NA | NA | NA | NA | 4 + L + Y |
| | | 2 TX Antennas RI > 2 | NA | NA | NA | NA | NA |
| | | 4 TX Antennas RI > 2 | NA | NA | NA | NA | 7 + L |
| | | 8 TX Antennas RI > 2 | NA | NA | NA | NA | 7 + L |

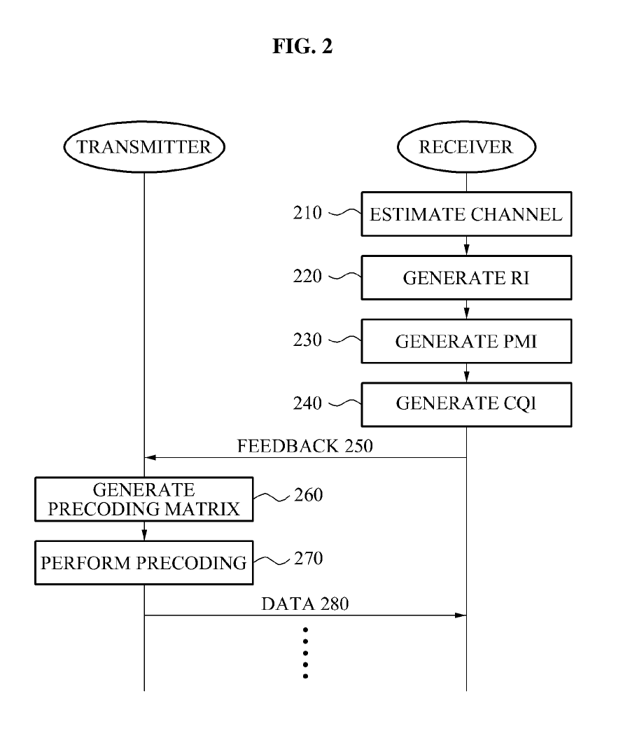

FIG. 2 illustrates an example of a communication method of a transmitter and a receiver, where the transmitter and receiver share a rank indicator, a precoding matrix indicator, and channel quality information.

Referring to FIG. 2, the receiver may correspond to a terminal in a downlink communication, and accordingly correspond to a base station in an uplink communication. The transmitter may correspond to the base station in a downlink communication, and accordingly correspond to the terminal in an uplink communication.

At 210, the receiver estimates a channel from the transmitter to the receiver. The receiver may estimate the channel using a known signal transmitted from the transmitter. The transmitter may include a plurality of transmit antennas, for example, two transmit antennas, four transmit antennas, eight transmit antennas, sixteen transmit antennas, and the like. The receiver includes at least one receive antenna.

At 220, the receiver generates a rank indicator (RI) indicating a number of preferred layers, for example, ranks. At 230, the receiver generates a precoding matrix indicator (PMI) indicating a preferred precoding matrix, using a predefined codebook based on the rank indicator. According to certain examples, at least two precoding matrix indicators may be generated based on at least two predefined codebooks. In this example, a final precoding matrix may be determined as an inner product between at least two precoding matrices selected from each of the at least two codebooks.

At 240, the receiver generates CQI based on the rank indicator and the precoding matrix indicator.

At 250, the receiver feeds back the rank indicator, the precoding matrix indicator, and CQI via a PUSCH or a PUCCH.

At 260, the transmitter generates a substantially optimal precoding matrix based on the fed back rank indicator, the precoding matrix indicator, and CQI. At 270, the transmitter precodes data streams. At 280, precoded data is transmitted to the receiver, for example, via the plurality of transmit antennas.

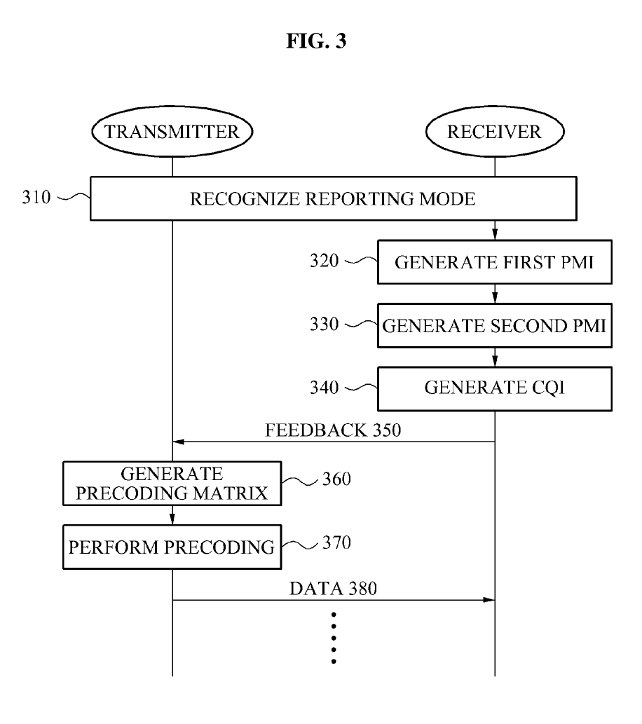

FIG. 3 illustrates an example of a transmitter and a receiver that share a first precoding matrix indicator, a second precoding matrix indictor, and channel quality information. Reporting mode 1-2.1 using a PUSCH and two reporting modes using a PUCCH are further described with reference to FIG. 3.

A communication method of a transmitter and a receiver operating according to reporting mode 1-2.1 using the PUSCH are described with reference to FIG. 3.

1. Reporting mode 1-2.1 using PUSCH

At 310, the transmitter and the receiver operate according to reporting mode 1-2.1 using the PUSCH.

At 320, the receiver generates a first precoding matrix indicator by selecting a first precoding matrix W₁ from a first codebook C₁. When a plurality of subbands is present, the receiver may generate, from the first codebook C₁, a precoding matrix indicator with respect to a set of subbands, if the transmitter performs a transmission in the set of subbands.

The first codebook C₁ may be different from a second codebook C₂, and the first codebook C₁ and the second codebook C₂ may be subsets of the same full codebook.

At 330, the receiver generates a second precoding matrix indicator by selecting a second precoding matrix W₂ from the second codebook C₂. In this example, if transmission occurs only in a selected subband with respect to each subband, the receiver may generate the second precoding matrix indicator of the second precoding matrix W₂ from the second codebook C₂.

At 340, the receiver determines one wideband CQI per codeword when transmitting in the set of subbands if a corresponding precoding matrix W is applied in each subband.

At 350, the receiver may feed back the first precoding matrix indicator, the second precoding matrix indicator, and the wideband CQI via the PUSCH.

The precoding matrix indicator and the CQI may be determined based on a reported rank indicator and a size of a subband may be determined according to various methods known in the art or specifically designed for the examples described herein. A threshold rank indicator RI_{threshold} may have various values, for example, 2.

At 360, when the first precoding matrix indicator, the second precoding matrix indicator, and the wideband CQI are fed back to the transmitter, the transmitter generates a substantially optimal precoding matrix using the first codebook C₁ and the second codebook C₂.

At 370, the transmitter precodes at least one data stream using the generated precoding matrix. At 380, the precoded at least one data stream may be transmitted via a plurality of transmit antennas.

2. Reporting Mode RI∥W₁∥W₂_{_{—}}_{W}, CQI_{—}W Using PUCCH

At 310, the receiver and the transmitter recognize a reporting mode with respect to feedback information. With respect to the present example, it may be assumed that a rank indicator indicating a preferred rank of the receiver is generated.

At 320, the receiver generates, from a first codebook C₁, a first precoding matrix indicator with respect to a set of a plurality of subbands or a predetermined subband among the plurality of subbands. A first precoding matrix corresponding to the first precoding matrix indicator may be referred to as W₁.

At 330, the receiver generates, from a second codebook C₂, a second precoding matrix indicator with respect to the set of the plurality of subbands. A second precoding matrix corresponding to the second precoding matrix indicator may be referred to as W₂_{_{—}}_{W}. W₂_{_{—}}_{W} may correspond to W₂ selected from the whole band, and be selected from the second codebook or a subset of the second codebook.

When the subset with respect to the second codebook includes only a single element, one-to-one mapping between W₁ and W₂_{_{—}}_{W} may be established. In such case, a precoding matrix indicator of W₂_{_{—}}_{W} may not be explicitly signaled.

At 340, the receiver ma determines wideband CQI_{—}W if the precoding matrix is a function of W₁ and W₂_{_{—}}_{W}. In this example, the receiver may determine CQI_{—}W with respect to the set of the plurality of subbands using the first precoding matrix indicator and the second precoding matrix indicator.

The precoding matrix indicator of W₂_{_{—}}_{W} and the wideband CQI_{—}W may be jointly encoded.

At 350, the receiver may transmit the rank indicator at a first reporting time and may transmit the first precoding matrix indicator at a second reporting time. The receiver may also feed back the second precoding matrix indicator with respect to the set of the plurality of subbands and CQI_{—}W with respect to the set of the plurality of subbands at a third reporting time.

Each of the first reporting time, the second reporting time, and the third reporting time may correspond to a different subframe.

In particular, the receiver may transmit the rank indicator based on a first reporting period and may transmit the first precoding matrix indicator based on a second reporting period. The receiver may also feed back the second precoding matrix indicator with respect to the set of the plurality of subbands and CQI with respect to the set of the plurality of subbands based on a third reporting period.

As described above with respect to reporting mode 1-2.1 using PUSCH, operations 360 through 380 are performed by the transmitter.

3. Reporting Mode RI∥W₁∥W₂_{_{—}}_{W}, CQI_{—}W∥W₂_{_{—}}_{S}, CQI_{—}S Using PUCCH

At 310, the receiver and the transmitter recognize a reporting mode with respect to feedback information.

At 320, the receiver generates, from a first codebook C₁, a first precoding matrix indicator with respect to a set of a plurality of subbands or a predetermined subband among the plurality of subbands. A first precoding matrix corresponding to the first precoding matrix indicator may be referred to as W₁.

At 330, the receiver generates, from a second codebook C₂, a second precoding matrix indicator with respect to the set of the plurality of subbands. A second precoding matrix corresponding to the second precoding matrix indicator may be referred to as W₂_{_{—}}_{W}. W₂_{_{—}}_{W} may correspond to W₂ selected from the whole band, and be selected from the second codebook or a subset of the second codebook.

When the subset with respect to the second codebook includes only a single element, one-to-one mapping between W₁ and W₂_{_{—}}_{W} may be established. In such case, a precoding matrix indicator of W₂_{_{—}}_{W} may not be explicitly signaled.

At 330, the receiver generates the second precoding matrix indicator with respect to the set of the plurality of subbands, and may also generate, from the second codebook C₂, a second precoding matrix indicator W₂_{_{—}}_{S} with respect to each predetermined subband. For clarity, the second precoding matrix indicator W₂_{_{—}}_{S} with respect to each predetermined subband is referred to in this example as a third precoding matrix indicator. Accordingly, at 330, the receiver may generate, from the second codebook C₂, W₂_{_{—}}_{W} and W₂_{_{—}}_{S}.

At 340, the receiver generates wideband CQI_{—}W and subband CQI_{—}S.

In this example, wideband CQI_{—}W may be determined if the precoding matrix is a function of W₁ and W₂_{_{—}}_{W}. CQI_{—}S may refer to subband CQI and may be obtained from a single subband. As an example, CQI_{—}S may be selected from a bandwidth portion. CQI_{—}S may be determined if the precoding matrix is a function of W₁ and W₂_{_{—}}_{S} in a subband.

At 350, the receiver feeds back, in four different subframes, the ‘rank indicator’, the ‘first precoding matrix indicator of W1’, the ‘second precoding matrix indicator of W₂_{_{—}}_{W} and CQI_{—}W’, and the ‘third precoding matrix indicator of W₂_{_{—}}_{S} and CQI_{—}S’.

The four different subframes may correspond to first to fourth reporting points.

As described above with respect to reporting mode 1-2.1 using PUSCH, operations 360 through 380 are performed by the transmitter.

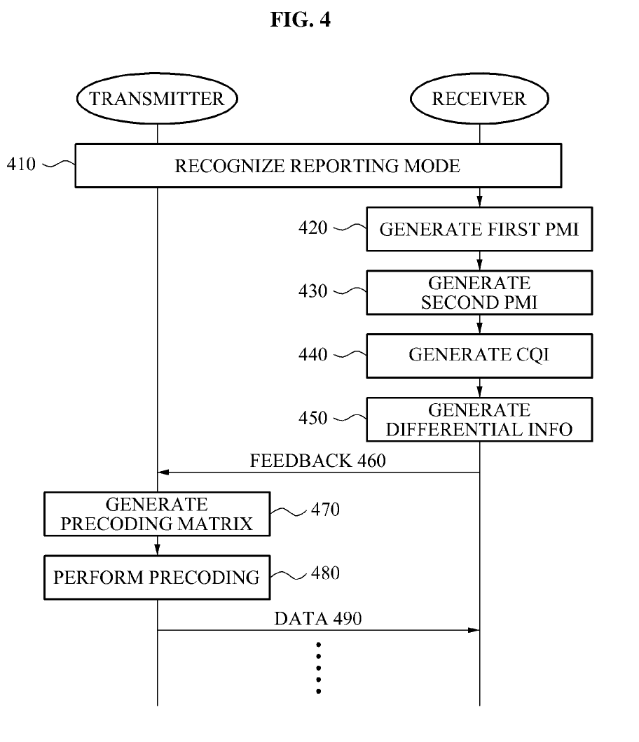

FIG. 4 illustrates an example of a transmitter and a receiver that share a first precoding matrix indicator, a second precoding matrix indicator, channel quality information, and differential information.

Here, reporting mode 3-1 using a PUSCH will be described with reference to FIG. 4.

At 410, the receiver and the transmitter recognize a reporting mode with respect to feedback information.

At 420, the receiver generates a first precoding matrix indicator by selecting a first precoding matrix W₁ from a first codebook C₁. When transmitting in a set of subbands, the first precoding matrix indicator of the single first precoding matrix W₁ may be generated from the first codebook C₁.

At 430, the receiver generates a second precoding matrix indicator by selecting a second precoding matrix W₂ from a second codebook C₂. When transmitting in the set of subbands, the first precoding matrix indicator of the single second precoding matrix W₂ may be generated from the second codebook C₂.

At 440, the receiver generates one subband CQI per codeword, and generates one wideband CQI per codeword with respect to each subband. In this example, the subband CQI may be determined when transmitting in the corresponding subband if W (that is, a function of W₁ and W₂) is applied in all of the subbands. Similarly, the wideband CQI may be determined when transmitting in the corresponding subband if W (that is, a function of W₁ and W₂) is applied in all of the subbands.

At 450, the receiver generates differential information associated with a difference between CQI associated with the set of the plurality of subbands and subband CQI associated with each codeword. The differential information may be encoded using single bit, two bits, three bits, and the like.

At 460, the receiver feeds back the first precoding matrix indicator, the second precoding matrix indicator, wideband CQI, and subband CQI. At least one of wideband CQI and subband CQI may be replaced with the differential information. All of the wideband CQI, the subband CQI, and the differential information may be fed back.

At 470, the transmitter generates a substantially optimal precoding matrix. At 480, the transmitter precodes at least one data stream using the generated precoding matrix. At 490, the precoded at least one data stream may be transmitted via a plurality of transmit antennas.

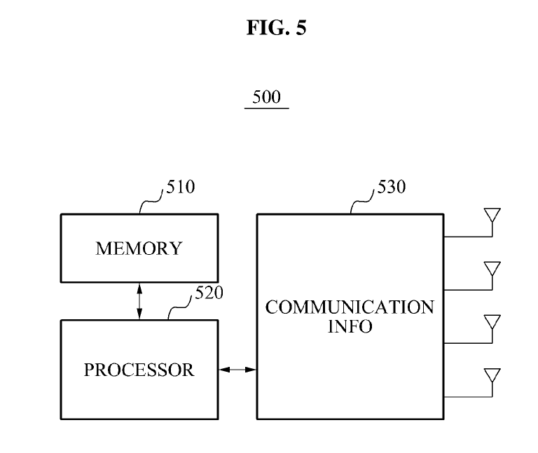

FIG. 5 illustrates an example of a communication apparatus 500. The communication apparatus 500 may be applicable to both a transmitter and a receiver.

Referring to FIG. 5, the communication apparatus 500 includes a memory 510, a processor 520, and a communication interface 530.

A first codebook and a second codebook, which are subsets of a full codebook, may be stored in the memory 510.

The processor 520 may generate a corresponding precoding matrix indicator from each of the first codebook and the second codebook, or may extract a corresponding precoding matrix corresponding to the corresponding precoding matrix indicator. For example, when the communication apparatus 500 is installed in or implemented at the receiver, the processor 520 may generate the corresponding precoding matrix from each of the first codebook and the second codebook. When the communication apparatus 500 is installed in or implemented at the transmitter, the processor 520 may extract the precoding matrix corresponding to the precoding matrix indicator generated from each of the first codebook and the second codebook. The processor 520 may also generate a precoding matrix to be finally applied, or may generate CQI. The aforementioned operations of the transmitter and the receiver may be generally performed by the processor 520.

The communication interface 530 may transmit or receive the corresponding matrix indicator generated from each of the first codebook and the second codebook.

The processes, functions, methods and/or software described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. The media and program instructions may be those specially designed and constructed, or they may be of the kind well-known and available to those having skill in the computer software arts. Examples of computer-readable storage media include magnetic media such as hard disks, floppy disks, and magnetic tape; optical media such as CD ROM disks and DVDs; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules that are recorded, stored, or fixed in one or more computer-readable storage media, in order to perform the operations and methods described above, or vice versa. In addition, a computer-readable storage medium may be distributed among computer systems connected through a network and non-transitory computer-readable codes or program instructions may be stored and executed in a decentralized manner.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A communication method of a receiver, comprising:
determining a reporting mode according to feedback information to be transmitted to a transmitter;
generating, from a first codebook, a first precoding matrix indicator with respect to a set of a plurality of subbands;
generating, from a second codebook, a second precoding matrix indicator with respect to at least one subband among the plurality of subbands; and
transmitting the feedback information to the transmitter, wherein the feedback information comprises the first precoding matrix indicator and the second precoding matrix indicator.

2. The communication method of claim 1, further comprising:
generating channel quality information associated with the set of the plurality of subbands, based on a precoding matrix that corresponds to each of the first precoding matrix indicator and the second precoding matrix indicator,
wherein the feedback information further comprises the channel quality information.

3. The communication method of claim 1, wherein the feedback information is transmitted via a physical uplink shared channel (PUSCH).

4. The communication method of claim 1, wherein the first codebook and the second codebook are different from each other, and each of the first codebook and the second codebook corresponds to a subset of the same full codebook.

5. The communication method of claim 2, wherein the channel quality information is generated based on a predetermined rank indicator or a rank indictor determined in the receiver.

6. A communication method of a transmitter, comprising:
determining a reporting mode according to feedback information transmitted from a receiver to the transmitter;
receiving a first precoding matrix indicator and a second precoding matrix indicator that are transmitted by the receiver according to the reporting mode; and
generating a precoding matrix based on the first precoding matrix indicator and the second precoding matrix indicator,
wherein, in the reporting mode, the first precoding matrix indicator is generated from a first codebook with respect to a set of a plurality of subbands, and the second precoding matrix indicator is generated from a second codebook with respect to each at least one subband among the plurality of subbands.

7. The communication method of claim 6, further comprising:
receiving channel quality information associated with the set of the plurality of subbands.

8. The communication method of claim 6, wherein, in the reporting mode, the channel quality information is generated based on the precoding matrix that corresponds to each of the first precoding matrix indicator and the second precoding matrix indicator.

9. The communication method of claim 6, wherein the first precoding matrix indicator and the second precoding matrix indicator are received via a physical uplink shared channel (PUSCH).

10. The communication method of claim 6, wherein the first codebook and the second codebook are different from each other, and each of the first codebook and the second codebook corresponds to a subset of the same full codebook.

11. A communication method of a receiver, comprising:
determining a reporting mode according to feedback information to be transmitted to a transmitter;
generating, from a first codebook, a first precoding matrix indicator with respect to a set of a plurality of subbands or at least one subband among the plurality of subbands;
generating, from a second codebook, a second precoding matrix indicator with respect to the set of the plurality of subbands or at least one subband among the plurality of subbands; and
transmitting the feedback information to the transmitter, wherein the feedback information comprises the first precoding matrix indicator and the second precoding matrix indicator.

12. The communication method of claim 11, further comprising:
generating channel quality information associated with the set of the plurality of subbands, based on a precoding matrix that corresponds to each of the first precoding matrix indicator and the second precoding matrix indicator,
wherein the feedback information further comprises the channel quality information.

13. The communication method of claim 12, further comprising:
generating differential information with respect to the channel quality information associated with the set of the plurality of subbands and channel quality information associated with a predetermined subband among the plurality of subbands,
wherein the feedback information further comprises the differential information.

14. The communication method of claim 11, wherein the first codebook and the second codebook are different from each other, and each of the first codebook and the second codebook corresponds to a subset of the same full codebook.

15. The communication method of claim 12, wherein the channel quality information is generated based on a predetermined rank indicator or a rank indicator determined in the receiver.

16. A communication method of a transmitter, comprising:
determining a reporting mode according to feedback information transmitted from a receiver to the transmitter;
receiving a first precoding matrix indicator and a second precoding matrix indicator that are transmitted by the receiver according to the reporting mode; and
generating a precoding matrix based on the first precoding matrix indicator and the second precoding matrix indicator,
wherein, in the reporting mode, the first precoding matrix indicator is generated from a first codebook with respect to a set of a plurality of subbands or at least one subband among the plurality of subbands, and the second precoding matrix indicator is generated from a second codebook with respect to the set of the plurality of subbands or at least one subband among the plurality of subbands.

17. The communication method of claim 16, further comprising:
receiving channel quality information associated with the set of the plurality of subbands.

18. The communication method of claim 17, further comprising:
receiving differential information with respect to the channel quality information associated with the set of the plurality of subbands and channel quality information associated with a predetermined subband among the plurality of subbands.

19. A communication method of a receiver, comprising:
generating a rank indicator indicating a preferred rank of the receiver;
generating, from a first codebook, a first precoding matrix indicator with respect to a set of a plurality of subbands or a predetermined subband among the plurality of subbands;
generating, from a second codebook, a second precoding matrix indicator with respect to the set of the plurality of subbands;
generating channel quality information associated with the set of the plurality of subbands; and
transmitting the rank indicator at a first reporting time, transmitting the first precoding matrix indicator at a second reporting time, and transmitting the second precoding matrix indicator and the channel quality information at a third reporting time.

20. The communication method of claim 19, wherein the first reporting point in time, the second reporting time, and the third reporting time each correspond to a different subframe.

21. The communication method of claim 19, wherein the second precoding matrix indicator and the channel quality information are jointly coded for transmission.

22. The communication method of claim 19, wherein the transmitting of the rank indicator, the first precoding matrix indicator, the second precoding matrix, and the channel quality information further comprises:
transmitting the rank indicator based on a first reporting period, transmitting the first precoding matrix indicator based on a second reporting period, and transmitting the second precoding matrix indicator and the channel quality information based on a third reporting period.

23. The communication method of claim 19, wherein the channel quality information is generated according to the first precoding matrix indicator and the second precoding matrix indicator.

24. A communication method of a transmitter, comprising:
determining a reporting mode according to feedback information transmitted from a receiver to the transmitter;
receiving, from the receiver, a rank indicator at a first reporting time, a first precoding matrix indicator at a second reporting time, and a second precoding matrix indicator with respect to a set of a plurality of subbands and channel quality information associated with the set of the plurality of subbands at a third reporting time;
determining, based on the reporting mode, the rank indicator, the first precoding matrix indicator, the second precoding matrix indicator, and the channel quality information; and
generating a precoding matrix based on at least the first precoding matrix indicator and the second precoding matrix indicator.

25. The communication method of claim 24, wherein the first reporting time, the second reporting time, and the third reporting time each correspond to a different subframe.

26. The communication method of claim 24, wherein the receiving further comprises:
receiving the rank indicator based on a first reporting period, receiving the first precoding matrix indicator based on a second reporting period, and receiving the second precoding matrix indicator and the channel quality information based on a third reporting period.

27. A communication method of a receiver, comprising:
generating a rank indicator indicating a preferred rank of the receiver;
generating, from a first codebook, a first precoding matrix indicator with respect to a set of a plurality of subbands or at least one predetermined subband among the plurality of subbands;
generating, from a second codebook, a second precoding matrix indicator with respect to the set of the plurality of subbands;
generating first channel quality information associated with the set of the plurality of subbands;
generating a third precoding matrix indicator with respect to each predetermined subband among the plurality of subbands;
generating second channel quality information associated with each predetermined subband among the plurality of subbands; and
transmitting the rank indicator at a first reporting time, transmitting the first precoding matrix indicator at a second reporting time, transmitting the second precoding matrix indicator and the first channel quality information at a third reporting time, and transmitting the third precoding matrix indicator and the second channel quality information at a fourth reporting time.

28. The communication method of claim 27, wherein the first reporting time, the second reporting time, the third reporting time, and the fourth reporting time each correspond to a different subframe.

29. The communication method of claim 27, wherein the transmitting further comprises:
transmitting the rank indicator based on a first reporting period, transmitting the first precoding matrix indicator based on a second reporting period, transmitting the second precoding matrix indicator and the channel quality information based on a third reporting period, and transmitting the third precoding matrix indicator and the channel quality information based on a fourth reporting period.

30. A communication method of a transmitter, comprising:
determining a reporting mode according to feedback information transmitted from a receiver to the transmitter;
receiving, from the receiver, a rank indicator at a first reporting time, receiving a first precoding matrix indicator with respect to a set of a plurality of subbands or at least one predetermined subband among the plurality of subbands at a second reporting time, receiving a second precoding matrix indicator with respect to the set of the plurality of subbands and first channel quality information associated with the set of the plurality of subbands at a third reporting time, and receiving a third precoding matrix indicator with respect to each predetermined subband and second channel quality information associated with each predetermined subband at a fourth reporting time;
determining, based on the reporting mode, the rank indicator, the first precoding matrix indicator, the second precoding matrix indicator, the first channel quality information, the third precoding matrix indicator, and the second channel quality information; and
generating a precoding matrix based on at least the first precoding matrix indicator, the second precoding matrix indicator, and the third precoding matrix indicator.

31. The communication method of claim 30, wherein the first reporting time, the second reporting time, the third reporting time, and the fourth reporting time each correspond to a different subframe.

32. The communication method of claim 30, wherein the receiving further comprises:
receiving the rank indicator based on a first reporting period, receiving the first precoding matrix indicator based on a second reporting period, receiving the second precoding matrix indicator and the first channel quality information based on a third reporting period, and receiving the third precoding matrix indicator and the second channel quality information based on a fourth reporting period.

33. A non-transitory computer-readable recording medium storing a program to implement the method of claim 1.

34. A communication apparatus installed in at least one of a transmitter and a receiver, comprising:
a memory configured to store a first codebook and a second codebook;
a processor configured to generate a corresponding precoding matrix indicator from each of the first codebook and the second codebook, and to extract a precoding matrix associated with the corresponding precoding matrix indicator; and
a communication interface configured to transmit and/or receive, between the transmitter and the receiver, the corresponding precoding matrix indicator generated from each of the first codebook and the second codebook,
wherein the first codebook and the second codebook are subsets of a full codebook.
